(19) United States
(12) Patent Application Publication
(10) Pub. No.: US 2020/0275060 A1
(43) Pub. Date: Aug. 27, 2020

(54) Equipment and Method for Audio/Visual Recording and Reproduction of Images/Films

(71) Applicant: Thomas Emde, Frankfurt (DE)

(72) Inventor: Thomas Emde, Frankfurt (DE)

(21) Appl. No.: 16/645,866

(22) PCT Filed: Sep. 7, 2018
(86) PCT No.: PCT/EP2018/074208

§ 371 Date: Mar. 10, 2020

(30) Foreign Application Priority Data
Sep. 11, 2017 (DE) 10 2017 120 956.5

(51) Int. Cl. H04N 7/18; H04N 5/247

(52) U.S. Cl. CPC H04N 7/181; H04N 5/247

(57) ABSTRACT

A device for audio/visual recording and reproduction of images/films comprising at least two cameras and at least two spatially separate display surfaces assigned to each one of these cameras for the reproduction of the images/films recorded by respectively one of these cameras in which the display surfaces are in each case windows of a room, wherein the windows are located in boundary surfaces of this room at an angle with respect to one another and wherein the images/films have been recorded by different cameras directed in different directions in each case. Alternatively to this, it is optionally possible to record with only one 360° camera and then different image sections can be created from this recording, which correspond to specific viewing directions and which are then projected onto respectively one window serving as display surface, which is aligned in the room according to the recording direction of the camera.

### CROSS REFERENCE TO RELATED APPLICATIONS

This application is the U.S. national stage of International Application No. PCT/EP2018/074208, filed on 2018 Sep. 7. The international application claims the priority of DE 102017120956.5 filed on 2017 Sep. 11; all applications are incorporated by reference herein in their entirety.

### BACKGROUND

The present invention relates to a device for audio/visual recording and reproduction of images/films comprising one or a plurality of cameras for the recording, which each record images/films seen by an observer directed in respectively different viewing directions and at least two spatially separate display surfaces for the reproduction, which are adapted for the respective reproduction of the images/films recorded by respectively one of these cameras and which are each assigned to a recording, wherein the display surfaces are in each case windows of a room and wherein the windows are located in boundary surfaces of this room at an angle with respect to one another.

Methods and devices for the spatial reproduction of images recorded with film cameras which is generally designated as 3D image reproduction are known from the prior art. For example, known in EP 2 800 350 A2 is an arrangement and a method for the recording and reproduction of images of a scene or of objects which are transferred to a suitable display surface so that the observer spatially perceives the images. Such images are recorded, for example, using a stereo camera comprising two cameras of the same type for respectively one left and one right image. Alternatively to this, there are also multiview cameras which are suitable for a correct image reproduction for multichannel systems. In these systems moving images or objects are recorded using several cameras from several different perspectives but with the aim of producing only one image acting three-dimensionally on the observer, which image is reproduced on a uniform cohesive 3D display observed by the viewer.

WO 00/25177 A1 describes a method for interactive audio/visual reproduction of a multiscene film whose width and/or height is greater than the visible section of the film in the film reproduction. In this method a panorama film backdrop is recorded in which the entire scene is composed of several different film sections which are not in an event relationship with one another. All the film scenes are recorded using a single camera which produces a quasi-360° all-round image. In addition to the optical recording, the respective noises pertaining to a scene are also recorded, wherein each optical scene is also assigned the appurtenant noise during the recording. In this known method the entire scene is reproduced on a projection screen which forms a hemisphere wherein the observer located at the centre of the hemisphere directs his eyes onto a certain angular range and then the scene section reproduced there can be observed. In this case, the system is adapted so that the respective viewing direction of the observer is identified and the noise pertaining to the respectively observed scene section is then played to him. In this known method, the aim is to reproduce sections of a multi-scene film by interactive action of the viewer as desired. The system assumes a spherical screen which surrounds the observer all around so that the observer is no longer in a natural surroundings of a room. The observer thus optically and acoustically only perceives here that reproduced by the multiscene film. An adaptation to a usually rectangular geometry of a typical room in a dwelling is not provided. In addition, in this known device it is specifically a question that when the viewing angle of the observer is changed, a different scene section is shown in each case which differs in its experience characteristic from the remaining scene sections.

Also known from the prior art are, for example, 270° screens in which the reproduction of the images/films always takes place on a curved surface.

Possibilities for using window surfaces of a room as a screen have become known from the prior art. Such a window element is already described, for example, in EP 1 366 265 B1. There the glass surface of a window element serves as a display surface, wherein an image produced independently of a projector is imaged on the window surface. Light-emitting diodes, for example, OLEDs or LEDs can be used for the display. Since OLED screens can be used, for example, which in the switched-off state are largely or even completely transparent, when the display is switched off a conventional window remains which is transparent for daylight and persons staying in the room can observe the surroundings unhindered through the window as in the case of a conventional window. It is thus avoided that persons feel cut off from the surroundings in any form as in a 3D screen of the type described above.

DE 10 2009 010 425 A1 describes an artificial window with a flat screen with spatial perception which is used to transfer the image of surroundings per camera from the control station of a cruise ship into inside cabins of the cruise ship so that the persons staying there can see the external surroundings visible in the control station. Here however, an artificial window is used as the display surface in which a flat screen is located in the window opening. This means that when the display is switched off, the observer cannot look outwards through the window. This is also technically not possible since this comprises an inside cabin of a ship which does not have an outside wall. Furthermore, in this known device only a single artificial window is used in each case, inside which a three-dimensional impression is produced by arranging several parallel screens spaced apart from one another one behind the other in the same window opening. This is not comparable with the situation in which the observer in a room finds several screens in different wall surfaces at an angle to one another on which images or films are reproduced in each case since the observer then sees images recorded from different perspectives, for example, next to him, in front of him or behind him.

In the Japanese Unexamined Laid-open Patent Application JP H09-187 573 A a type of flight simulator is described in which a person is located in a capsule which can execute various movements with respect to the surroundings, namely rotational movements and also translational movements in the height direction as well as laterally, i.e. therefore in the X, Y and Z direction. These movements are initiated by the person in the capsule via an operating lever. In order to give the person the impression that the capsule is located in space, images are reproduced via windows aligned in different spatial directions and changed so that the images simulate the respective movement of the capsule in space. The “windows” used here are virtual windows however which serve as display windows for the reproduction of the images. These windows are installed on the wall of the interior of the capsule, i.e. in front of the wall. These are therefore not genuine windows through which one can see when the display is switched off. In this known device, it is also the case that the room (capsule) in which the person stays moves with respect to its surroundings and there is a direct relationship between these movements and the images reproduced on the display surfaces of the artificial windows insofar as the image changes similarly to the respective movement of the capsule in order to quasi-simulate the genuineness of the movement during a flight with a spacecraft to the observer. This is therefore similar to the functioning principle of a flight simulator. In such a known device, the observer is visually isolated from the real surroundings similar as in the inside cabin of a ship, i.e. he only sees that reproduced on the screen of the virtual window but cannot observe the real external surroundings of the room in which he is located. This known device is rather suitable for a pleasure park and is technically very complex since this requires a complex support structure for suspending the device and various drives for movement of the device in the different directions.

Furthermore, several cameras are used here which are aligned in different directions of the room, for example, orthogonal to one another, which however stand on a tripod so that the cameras do not move with respect to the surroundings.

### SUMMARY

The present invention relates to a device for audio/visual recording and reproduction of images/films comprising at least two cameras (22, 23) and at least two spatially separate display surfaces (16, 17) assigned to each one of these cameras for the reproduction of the images/films recorded by respectively one of these cameras (22, 23) in which, according to the invention, the display surfaces (16, 17) are in each case windows of a room (10), wherein the windows are located in boundary surfaces (12, 15) of this room (10) at an angle with respect to one another and wherein the images/films have been recorded by different cameras (22, 23) directed in different directions in each case. Alternatively to this, it is optionally possible to record with only one 360° camera and then different image sections can be created from this recording, which correspond to specific viewing directions and which are then projected onto respectively one window serving as display surface, which is aligned in the room according to the recording direction of the camera.

### DETAILED DESCRIPTION

It is the object of the present invention to provide a less complexly configured device for audio/visual reproduction of images/films having the features mentioned initially in which a plurality of image sequences/films in a scenic relationship can be reproduced on spatially separate display surfaces in an everyday living or working environment without isolating the observer from his surroundings by a specific screen or the like.

The aforesaid object is provided by a device for audio/visual reproduction of images/films of the type mentioned initially having the features of claim 1.

According to the invention, it is provided that the room is a room which does not move with respect to the surroundings outside the room, in particular in a building and that the camera or the cameras by means of which the images/films shown on the display surfaces are recorded are installed on a moving object or such a recording of a camera is simulated.

In the last-mentioned variant of the invention no camera is required since the corresponding images/films (photosimulation) are created with electronic means, for example, by means of a suitable software. Here however, the same effect can be achieved in principle. When there is talk of a “camera” or “cameras” in the present application, this term then includes a real camera or a virtual camera, that is, a device which produces an image of a camera in an electronic manner.

The present invention thus describes a different path than the previously described prior art. The room in which the observer is located does not move with respect to the surroundings. On the contrary, this comprises a completely normal room, for example, in a dwelling house or in an office. Located in the walls of the room are two, optionally more windows, which are located in boundary surfaces of this room at an angle to one another. These windows have the function of display surfaces on which images or films (moving images) are reproduced, which have been recorded by means of several cameras from different viewing angles or optionally a single camera on a moving object which records all around so that the observer has the impression that he is located in a moving object, wherein various viewing angles are reproduced on the various display surfaces at an angle to one another, such as one sees, for example, on a vehicle when one looks to the front or to the side or to the rear, for example. In the solution according to the invention, images are thus reproduced on the display surfaces which simulate a movement but these images are decoupled from the room in which the person is located, i.e. the room and the person located therein do not move.

The solution according to the invention is therefore technically considerably less complex and can be installed in a very ordinary room in a building. Merely a corresponding number of displays suitable for reproducing the images is required.

Preferably, according to a further development of the invention, the display surfaces are each windows, which are largely transparent when the display is switched off and allow a view towards the outside of the room into the surroundings. This means that the window surfaces comprise largely transparent glass or plastic glass surfaces (acrylic glass) which fulfil the function of a normal window when the display is switched off so that the person in the room can look outwards through one of the windows. When the display function is switched on however, these window surfaces serve as display surfaces. This double function can be implemented, for example, by using transparent OLED displays or by using windows which comprise such transparent OLED displays as a layer of an arrangement of layers which is overall transparent when the display is switched off. This preferred variant of the invention has the advantage that when the display is switched off, the display function is almost not perceived for the observer so that a completely normal room situation is involved in which the observer can look outwards and daylight falls into the room. The person in the room is therefore not cut off from the external surroundings.

Within the framework of the invention, for example but not exclusively, windows with display functions can be used such as are described in the aforesaid EP 1 366 265 B1.

When the display function is switched off, the person need not bring about movements of the room via an operating function as in the space capsule according to the above-described prior art but the images/films run independently on the display surfaces so that the person can pursue any normal activity in the room. Nevertheless, the effect which is brought about via the display surfaces is such that the person in the room has the feeling that he is located in a moving object.

The device according to the invention for the audio/visual recording and reproduction of images/films can, for example, comprise at least two cameras which are equipped with regard to their technical specification in the same way as the devices for reproduction of the images/films in such a manner that they correspond as accurately as possible to the human perception. This can be achieved, for example, by taking into account a series of measurable parameters, such as, for example, the resolution, the image rate, the contrast, the brightness range, the focal width during the recording and/or the sound quality, in particular with regard to the spatial impression, the dynamics, the sharpness of the reproduction of heights and depths and the like.

Thus, the resolution can, for example, be at least 4K, the image rate, for example, at least 60 images per second, contrast/brightness range can be achieved by as loss-free as possible dynamic compression or as high as possible dynamic range, for example, by using HDR technology and the focal width can, for example, be about 45×35 mm, which corresponds to a small image format and approximately the focal width of the human eye.

The core idea of the present invention consists in imaging images, preferably moving images, on such window surfaces which are transparent when the display is switched off, which image a surroundings recorded by various cameras and specifically directed in respectively different viewing directions when viewed from a reference point so that the images correspond to the perception of a person such as he experiences his surroundings at the time of the recording when he looks in various directions. The present invention follows a different path compared to the generation of a typical 3D recording using conventional technology. In the latter several cameras record the same scene in order to subsequently achieve a spatial three-dimensional perception when playing back the scene on a flat screen. Or however, a screen surface surrounds the person all around so that the observer perceives different sections of the screen when he changes his viewing angle by rotating.

Instead of using several cameras, a suitable all-around camera can also be used which records an image section with a large viewing angle, wherein then such a recording can be separated during processing into several recordings with smaller viewing angles which are then reproduced on the individual display surfaces.

In the solution according to the invention, for example, an image of a surroundings directed in a specific first direction is recorded using a first camera and then using a second and optionally further camera, an image of the same surroundings is recorded, for example directed at the same time in a second or third direction, which does not agree with the first viewing direction, wherein the respective image section usually does not overlap. The recording therefore takes place according to the invention from a viewpoint in different directions, which thus corresponds to the image impression which a person has when he turns his head, for example, in different directions from his location, wherein the location varies continuously, which corresponds to an image impression which a person, an animal or an object has which moves in a surroundings (i.e. this does not involve a recording of a moving object from different viewing angles).

These different recordings of the same surroundings/scene are then reproduced on two or more display surfaces configured as windows, wherein these display surfaces are at an angle to one another, wherein preferably the respective angular positions of the display surfaces correlate to one another approximately with the perspective recorded previously in each case by the cameras. This creates the possibility that the person located in a room with several such windows suitable as display surfaces can observe various partial images of respectively the same scene by observing different window surfaces, with the result that a very immediate experience of this scene can be produced, which comes very close to the scene recorded by means of the camera. Nevertheless with the solution according to the invention, the advantage remains that unlike in an all-around display, the user remains in his usual surroundings, that is, he can, for example, pursue a different activity whilst a film runs on the display. The person is therefore not forced to exclusively observe the played-back film. On the contrary, a reproduction of, for example, moving images as in a film can be allowed to run merely in the background, as it were, in order to create a type of decorative surroundings and a specific atmosphere for the persons in the room without the persons thereby being forced to always watch this film.

A possible preferred variant of the present invention provides that the recording takes place using at least two cameras and the reproduction of the images takes place on at least two display surfaces configured as windows which are located in boundary surfaces of the room approximately at right angles to one another. Usually rooms in buildings are designed so that at least two of their walls are approximately at right angles to one another. Preferably located in each of these walls is a window which according to the invention is configured as a display and is suitable for reproduction of images/films. If a person is located in such a room, he can, for example, observe images of a first scene on a display which is formed by a window in a wall to which this person looks in a standard position, for example, sitting at a table. A second window configured as a display can then be located, for example, in a second wall which runs laterally to this person, so that the display can be observed when the person turns by about 90° to the side. A scene which had been recorded previously by means of two cameras when viewed in different directions then runs on both displays.

An alternative variant of the present invention provides that the device for audio/visual recording and reproduction of images/films comprises only one camera which records a 360° recording all around and at least two spatially separate display surfaces for the reproduction of the images/films recorded by this camera are provided, wherein the display surfaces are each windows of a room, wherein the windows are located in boundary surfaces of this room located at an angle to one another and wherein image sections of the images/films of the camera corresponding to the relative spatial position of these windows, which have been recorded directed in respectively different directions, are each reproduced on the display surfaces.

It is further preferred that the recording is carried out using at least three cameras from the same viewpoint directed in respectively different directions or using one camera which records a 360° recording all around and the reproduction of the images is carried out on at least three display surfaces each configured as windows, of which at least two are located in boundary surfaces of the room approximately at right angles to one another and at least two are located in boundary surfaces of the room arranged approximately parallel to one another and opposite one another. These can be, for example, a display surface in a wall in front of a sitting person and two display surfaces each located to the right or left side of this person.

The “same viewpoint” mentioned here is a locally variable viewpoint when, for example, the sight of a moving person or a moving animal or object is simulated. The recording is made using two, three or more cameras from the respective viewpoint directed in different viewing directions. The recorded scenes are therefore then those such as are obtained by a running person or a moving object when one looks out from this in different viewing directions.

It is particularly preferred that the recording is carried out using at least four cameras from the same viewpoint when viewed in respectively different directions or using one camera which records a 360° recording all around and the reproduction of the images is carried out on at least four display surfaces each configured as windows, of which respectively two are located in boundary surfaces of the room approximately at right angles to one another and respectively two are located in boundary surfaces of the room arranged approximately parallel to one another and opposite one another. The person can then observe a first display surface when looking towards the front, when he directs his view to the right or left in each case, he can observe a display surface arranged laterally with respect to him and when the person turns round, he can then observe a further scene recorded by the fourth camera or the 360° camera, which in turns shows a different viewing direction compared to the images on the other display surfaces, but preferably in each case perspectives which have been recorded using different cameras in the same ambient situation in each case.

The application of the invention is not restricted to windows or other glass surfaces as display surfaces which are located in a wall of a room but for example, a display surface can also be located, for example, on the ceiling of a room. In this case, the recording can be made using five cameras of which one is directed upwards.

When there is talk of “windows” as display surfaces in the present application, this is not meant restrictively in that it must comprise windows in the actual sense but instead, any other glass surfaces or optionally plastic surfaces suitable as display surfaces in a room or building also come into consideration, for example, glass doors, such as patio doors, balcony doors or glass facade parts, glass dividing walls, glass ceilings, glass roofs or glass surfaces of furniture, mirror surfaces, transparent plastic surfaces or the like.

Preferably it is therefore the case that the recording is carried out using several cameras in different directions or using one camera which records a 360° recording all around in each case simultaneously or approximately simultaneously. This produces a particular effect since the recording cameras are each located on an object which executes a relative movement with respect to the surroundings recorded by the camera. This relative movement of one or several cameras can however optionally also be simulated by means of a suitable software so that the recording by means of the camera is not necessary in this case.

Preferably it is also the case that in addition to the image recording, a sound recording is carried out in each case from the corresponding perspective and during reproduction the sound recording assigned to the respective display surface is played. The person observing the display surfaces then hears a noise backdrop which is overall similar since it originates from the same recorded ambient situation but the recorded sound is somewhat different for each camera in each case since the direction from which the sound comes is different in each case. During the reproduction this spatial sound effect perceived in the recording situation can be reproduced in a corresponding manner so that the reproduction very realistically reproduces the sound situation during the recording.

Preferably the arrangement of the display surfaces is such that a first display surface is arranged approximately frontally in front of a person observing this and at least one further display surface is arranged approximately laterally to the person observing this, wherein the first display surface and the further display surface preferably adopt an acute angle or a right angle to one another.

It is furthermore preferably the case that a first display surface is arranged approximately frontally in front of a person observing this, at least one second display surface is arranged approximately laterally to the person observing this, wherein the first display surface and the further display surface preferably adopt an acute angle or a right angle to one another, and at least one third display surface is arranged approximately opposite the further display surface or opposite to this in an offset manner.

Preferred is an arrangement in which a first display surface is arranged approximately frontally in front of a person observing this and at least one second display surface is arranged approximately behind the person observing this, wherein the first display surface and the second display surface are preferably arranged opposite one another or opposite one another in an offset manner.

Particularly preferred is an arrangement in which a first display surface is arranged approximately frontally in front of a person observing this, at least one second display surface is arranged approximately laterally to the person observing this, wherein the first display surface and the further display surface preferably adopt an acute angle or a right angle to one another, at least one third display surface is arranged approximately opposite the further display surface or opposite to this in an offset manner and at least one fourth display surface is arranged approximately opposite the first display surface or opposite to this in an offset manner.

The recording situation is preferably selected so that images/films are recorded by means of a first camera, which recorded with a perspective aligned in a first direction, that furthermore images are recorded using a second camera preferably at the same time as the images of the first camera, wherein the second camera records with a perspective aligned in a second direction, which is aligned at an acute or right angle to the first direction and that furthermore images are recorded with a third camera preferably at the same time as the images of the first and second camera, wherein the third camera records with a perspective aligned in a third direction which is aligned approximately opposite to the first direction. Alternatively, all the images are recorded by a 360° camera which records an all-round recording at the same time wherein then the corresponding image sections which each correspond to the perspective of the display surfaces are reproduced on the display surfaces.

Particularly preferably at least four cameras are used for the recording, i.e. in this case, images are furthermore recorded using a fourth camera preferably at the same time as the images of the first, second and third camera, wherein the fourth camera records with a perspective aligned in a fourth direction which is aligned approximately opposite to the second direction. Alternatively here all four images can also be recorded by a 360° camera wherein then the corresponding four image sections are reproduced on the four display surfaces.

According to the present invention, the recording of the images/films takes place by means of cameras or a camera located on a moving object.

This moving object can, for example, be a motor vehicle, a rail vehicle, a bicycle, a boat, an aircraft, a spaceship, a running person or a running animal. Such recordings subsequently produce the effect for the observer that he is moving according to the camera during the recording at the speed of the moving object with respect to the recorded surroundings. In the case of a motor vehicle, for example, an automobile or a motorcycle, this can be a rapid relative movement or however in the case of a bicycle, a correspondingly slower movement. Recordings from a running animal such as, for example, a horse or dog produce further interesting effects for the observer, on the one hand since a horse or a dog can also move away from roads or larger routes and since the camera also reproduces the movement produced by the specific type of motion (for example, up and down). Added to this are different distances from the ground level on which the animal is running. In the case of a dog, the camera which is located, for example, on the back of the animal moves comparatively close to the ground whereas in the case of a horse the distance from the ground is considerably greater. In the case of a camera on a dog, further effects are obtained as a result of the fact that the dog can roam away from paths, for example, through the undergrowth and the observer sees the images recorded by the cameras from the corresponding perspective of the dog, in each case seen in different viewing directions.

Alternatively, for example, recordings are possible from a bird's perspective which can be recorded by an aircraft or by a drone. Recordings from a spaceship, for example, are also possible wherein in this case, the recording need not necessarily really be made using several cameras but the camera recordings can be simulated here by means of computers, wherein as in the other aforementioned examples, the recording here can also be simulated with several cameras directed in respectively different viewing directions and the corresponding recordings are transferred to the various displays in the room in which the person viewing these is located, wherein the reproduction takes place on these displays so that the corresponding display on which the reproduction is made in each case corresponds with regard to the direction to that direction in which the respective camera was aligned during the recording.

According to one variant of the present invention, recordings which were not recorded from a moving object can alternatively be shown on the displays in a specific mode so that, for example a scene can also be shown which was recorded by several cameras in a rest position in each case in several different viewing directions. In the scene recorded by the cameras, persons or animals can move whereas the cameras retain their position. For example, a nature scene can be recorded and the cameras capture with their image and sound recordings the corresponding mood of this scene (for example, a forest scene in the evening or a sunset over the sea) viewed in several different directions and during the reproduction reproduce this mood on the multiple displays in the room for the observer. In this way, a very atmospheric reproduction close to reality is possible which produces the impression for the person in the room that he is located in the forest or on the sea where the images were recorded, wherein however unlike in the case of a 3D film with a screen surrounding the observer all around, the observer is nevertheless located in his real surroundings as previously and can pursue any activity. He is therefore in no way forced to observe the images produced on the display. This is also a substantial difference from observing images/films by means of cyber glasses. There the observer dips into a virtual environment and is thus cut off from the real surroundings and the real events around him. In the solution according to the invention however, this is not the case but the observer stays in the midst of his original surroundings, for example, a living room or a work room and can thus pursue any activity within his natural surroundings without any restriction. The images/films to be observed on the displays relating to the virtual surroundings either deliver only an atmosphere by means of which, for example certain memories of this person can be transported, for example, memories of holiday spent, by reproducing images from the holiday, or however they offer the person the option to optionally observe images played on the display. Thus, as it were a virtual surroundings is made available to the observer optionally in the real surroundings. This alternative mode can then be set, for example, when the person desires a calming mood, for example, in the evening or in a rest phase used for relaxation.

The present invention further relates to a method for audio/visual recording of images/films by means of at least three cameras or by means of one camera which records a 360° recording all around, wherein these images/films are provided for a reproduction on spatially separate display surfaces of a device having the features described above, wherein during recording by means of at least three cameras, images/films are recorded by means of a first camera, which records from a movable viewpoint aligned in a first direction, wherein furthermore images are recorded using a second camera preferably at the same time as the images of the first camera, wherein the second camera records from the same movable viewpoint aligned in a second direction, which is aligned at an acute or a right angle to the first direction and wherein furthermore, images are recorded using a third camera preferably at the same time as the images of the first and second camera, wherein the third camera records from the same movable viewpoint aligned in a third direction, which is aligned approximately opposite to the first direction or that when using only one camera which records a 360° recording all around, at least three image sections are created from the 360° recording, which show images which are aligned from the same movable viewpoint in a first direction, a second direction and a third direction as described previously.

According to a preferred further development of the aforesaid method, furthermore images are recorded using a fourth camera preferably at the same time as the images of the first, second and third camera, wherein the fourth camera records aligned in a fourth direction, which is aligned approximately opposite to the second direction or when using only one camera, which records a 360° recording all around, a fourth image section is created which shows images which are aligned from the same movable viewpoint in a fourth direction as described previously.

Preferably the images/films are recorded by means of two, three or four cameras or only one 360° camera located on a moving object.

Preferably the movable object is a motor vehicle, a rail vehicle, a bicycle, a boat, an aircraft, a spaceship, a running person or a running animal.

The features mentioned in the subclaims relate to preferred embodiments of the invention. Further advantages are obtained from the following detailed description.

### BRIEF DESCRIPTION OF THE DRAWINGS

The present invention is explained in detail hereinafter by means of exemplary embodiments with reference to the appended drawings. In the drawings:

FIG. 1 shows a schematic view of an exemplary room with a device for audio/visual reproduction of previously recorded images/film according to one possible embodiment of the present invention;

FIG. 2 shows a schematic view of a scene in which the recording of images/films is made by means of several cameras according to the present invention.

### DETAILED DESCRIPTION OF THE PREFERRED EMBODIMENTS

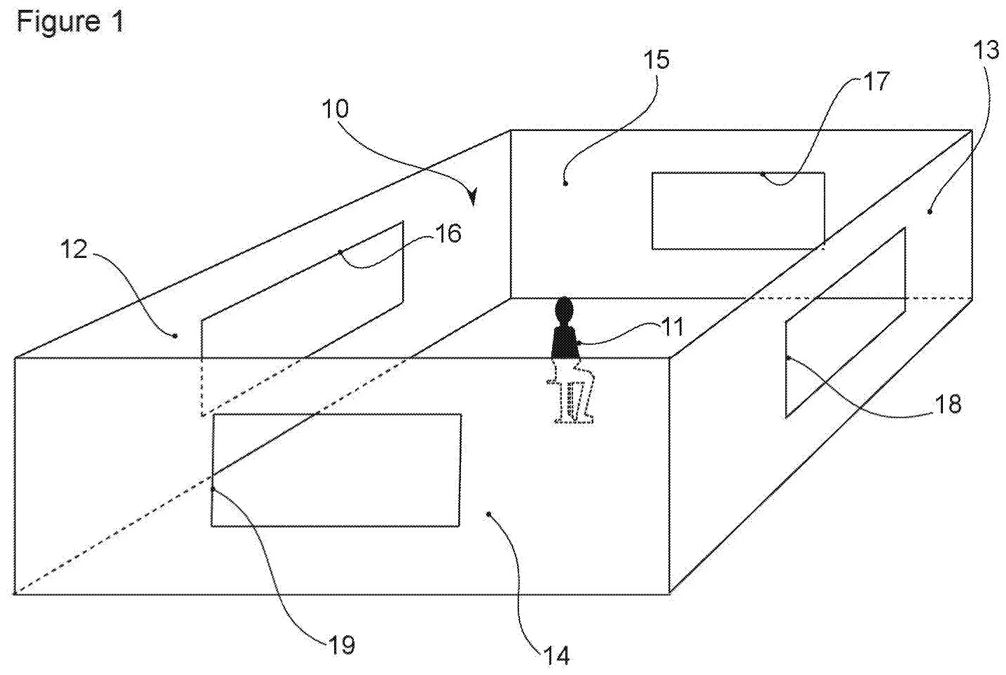

Reference is initially made to FIG. 1 which shows in a highly schematic simplified manner a for example, substantially cuboid room 10 in which a person 11 is located, who uses this room 10, for example, as a living room or alternatively to this also as a work room. The room can therefore, for example also comprise an office or a publically used room of an exhibition, a museum or the like. The room 10 can, however also be a private living room, bedroom or any other room. In the exemplary embodiment according to FIG. 1, the room 10 is equipped with four walls each aligned approximately perpendicular to one another. However, this room variant should only serve for exemplary viewing since naturally this room 10 can also in principle have any outline form differing from a rectangular outline. For example, the walls can be at an acute angle to one another or be partially rounded and additional projections, niches or the like can be provided, likewise the room can also, for example, have only three walls. The room geometry is therefore not subject to any specific restriction. Only a standard room was shown in the example by means of which the invention is explained.

The approximately rectangular room 10 in outline shown in FIG. 1 comprises, for example, four walls, namely a left side wall 12, a right side wall 13 which lies opposite the left side wall 12 and runs approximately parallel to this, a rear wall 14 which is a transverse wall relative to the two side walls 12 and 13 and therefore runs approximately at right angles to these two side walls 12, 13 and connects these to one another at one end thereof. In addition, a front wall 15 is also provided which runs approximately parallel and at a distance from the rear wall and thus lies opposite the rear wall 14 and forms a second transverse wall of the room. This front wall 15 thus connects the two side walls 12 and 13 to one another at their other end opposite the rear wall 14. These four walls 12, 13, 14, 15 thus span an approximately rectangular room 10 in outline inside which the person 11 viewing the images stays, for example, approximately in a central area. In this way, the person 11 can observe the front wall 15 when he looks to the front, when he turns his head to the left, he can observe the left side wall 12, when he turns his head to the right, he can observe the right side wall 13 and when he turns round, he views the rear wall 14 of the room behind him.

The terms selected in the above paragraph, left side wall, right side wall, rear wall, front wall are here selected randomly in principle since these designations are dependent on the respective orientation of the observer. These terms therefore only serve for better illustration here. The four walls of this room could equally well also be designated as first wall, second wall, third wall and fourth wall. If the four walls are then considered here for example in the clockwise direction, beginning with the left side wall 12, this then forms the first wall, the front wall 15 forms a second wall, the right side wall 13 forms a third wall and the rear wall 14 forms a fourth wall. Merely of importance in the context of the present invention is that several walls are involved which are each at an angle to one another and form a room, wherein this room also does not need to be a closed room. If, for example it comprises a room with only three walls, the room would then be open on one side.

Now located on each of the above-described four walls 12, 13, 14, 15 of the room 10 is a display surface in each case which according to the invention is configured as a window which is suitable to produce images or films on the display surface. Located in the left side wall 12 is a first window 16 which forms a first display surface. Located in the front wall 15 is a second window 17 which forms a second display surface. Located in the right side wall 13 is a third window 18 which forms a third display surface and located in the rear wall 14 is a fourth window 19 which forms a fourth display surface. These four windows can each comprise OLED display surfaces in which any images can be produced, in principle as in an OLED television. In the switched-off state however, these OLED display surfaces are transparent or largely transparent so that the person can see through each of the windows 16, 17, 18, 19 and can observe the surroundings outside the room as soon as the corresponding display is switched off. This essentially distinguishes the device according to the invention from a 3D screen with curved surface which surrounds the person all around like a screen and which naturally does not allow seeing through even when the display is switched off. In addition, the solution according to the invention has the advantage that the surfaces of the four windows 16, 17, 18, 19 let daylight through when the display is switched off in each case so that the room is not darkened during the day.

A further particular feature of the present invention lies in that the display surfaces formed by the four windows 16, 17, 18, 19 do not form a cohesive display surface but are separate from one another, are each at a distance from one another and are each located on or on different walls of the room. When the person 11 located, for example, approximately in the central region of the room 10 observes the display surface 17 (or the window 17) on the front wall 15, for example, when the display function is switched on, he usually does not simultaneously also identify with his viewing angle the display surface 16 on the left side wall 12 or the display surface 18 on the right side wall 13. The person can in any case only identify the fourth display surface 19 on the rear wall 14 if he turns through about 180° about his own axis in the room. However, by turning his head or his body, the person can comparatively rapidly change from observing one display surface to the other if the display functions are switched on in each case.

A further particular feature of the invention consists in that preferably various partial scenes are played on the display surfaces in each case, which however are in a scenic relationship insofar as these partial scenes have been recorded in the same situation with different cameras from different viewing angles, preferably at the same time. This means that several partial scenes are then played on the display surfaces which partial scenes pertain to a complete scene and in principle reproduce a situation which is related to one another but can be observed by the observer from different perspectives according to which of the display surfaces he observes, according to the respective viewing angle of the camera when recording the corresponding partial scene.

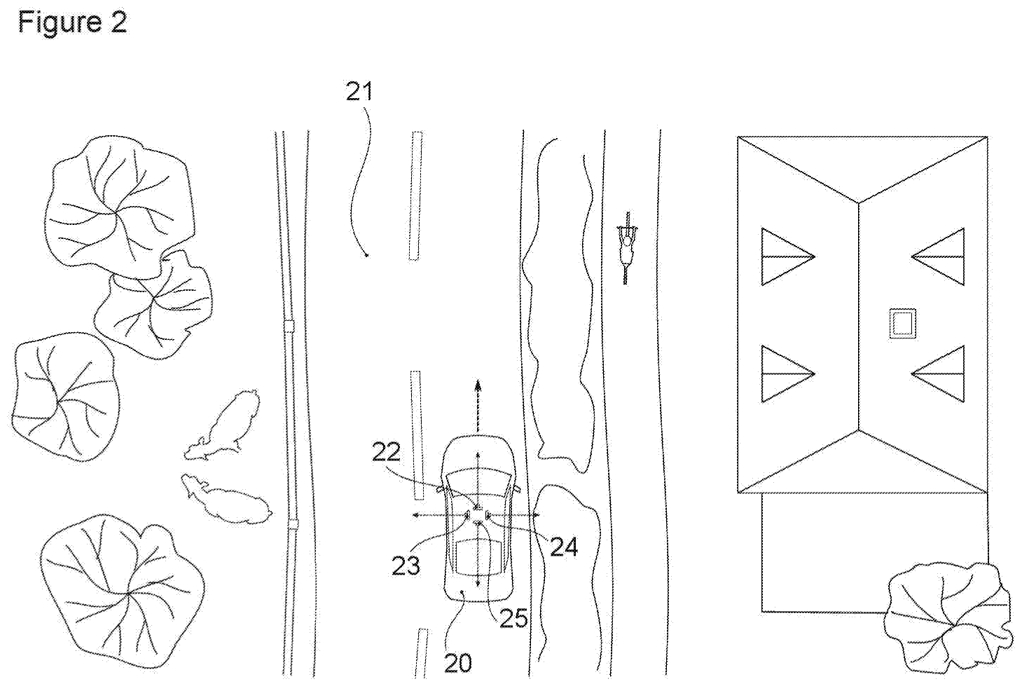

This aspect of the present invention is explained in detail hereinafter with reference to FIG. 2. This diagram shows as an example a vehicle 20 which is travelling along a road 21 through a landscape. Several cameras which record the surroundings of the travelling vehicle 20 are mounted on the vehicle 20, for example, on the roof or on the top of the bonnet and/or in the rear. In the example, this comprises four cameras which are all aligned in a respectively different direction. The cameras can thus each simultaneously record image and sound of the same scene, namely the surroundings of the travelling vehicle but from respectively different perspectives. For example, a first camera 23 is aligned so that it records approximately at right angles to the left from the vehicle 20. A second camera 22 is aligned towards the front from the vehicle and thus records a partial scene as shown to an observer who looks towards the front from the travelling vehicle. A third camera 24 is aligned to the right towards the side from the vehicle 20 and thus records a partial scene as shown to the observer when he looks out to the left from the travelling vehicle from the side window. Finally a fourth camera 25 is provided which is mounted on the vehicle 20 so that it is aligned towards the rear so that it records a partial scene as shown to the observer who looks out towards the rear from the travelling vehicle 20.

The first camera 23 is thus directed to the left and the third camera 24 records at an angle of about 180° to the first camera (seen in plan view) so that the scenery passing by is recorded from different perspectives in each case.

The second camera 22 is directed towards the front and thus records at an angle of about 90° in each case to the first camera 23 and to the third camera 24. The second camera 22 therefore captures a partial scene such as perceived possibly by the driver of the vehicle who identifies the road and the scenery on both sides away from the road, in each case with a restricted viewing angle, for example, similar to that which can be identified by the human eye. When the vehicle 20 is travelling fast, the second camera 22 records a scene which approaches the observer rapidly.

The fourth camera 25 aligned towards the rear records at an angle of about 180° compared to the second camera 22. When the vehicle is travelling rapidly, a scene is recorded such as that shown to anyone who looks through the rear window of the vehicle 20 during the journey, that is the observer sees a rapidly distancing scene with the road and the surrounding scenery according to the restricted viewing angle which a person has who looks from the rear window of the vehicle during the journey.

The four scenes preferably recorded simultaneously in the same surroundings by means of the four cameras 22, 23, 24, 25 shown in FIG. 2 are then played back on the four displays formed by the four windows 16, 17, 18, 19 in the room 10, shown in FIG. 1, and specifically in such a manner that the images recorded by the first camera 23 are reproduced on the first window 16 in the left side wall 12, the images recorded by the second camera 22 are reproduced on the second window 17 on the front wall 15, the images recorded by the third camera 24 are reproduced on the third window 18 in the right side wall 13 and the images recorded by the fourth camera 25 are reproduced on the fourth window 19 in the rear wall 14. As a result, the observer sees on the respective displays on the four walls surrounding him in his room in each case those images which with regard to their recording perspective precisely correspond to the spatial direction in which the observer sees the images reproduced on the displays.

### LIST OF REFERENCE NUMERALS

10 Room
11 Person
12 Left side wall
13 Right side wall
14 Rear wall
15 Front wall
16 First window
17 Second window
18 Third window
19 Fourth window
20 Vehicle
21 Road
22 Second camera
23 First camera
24 Third camera
25 Fourth camera

1. A device for audio/visual recording and reproduction of images/films comprising one or a plurality of cameras (22, 23) for the recording, which each record images/films seen by an observer directed in respectively different viewing directions and at least two spatially separate display surfaces (16, 17) for the reproduction, which are adapted for the respective reproduction of the images/films recorded by respectively one of these cameras (22, 23) and which are each assigned to a recording, wherein the display surfaces (16, 17) are in each case windows of a room and wherein the windows are located in boundary surfaces (12, 15) of this room at an angle with respect to one another, characterized in that the room is a room which does not move with respect to the surroundings outside the room, in particular in a building and that the camera or the cameras by means of which the images/films shown on the display surfaces (16, 17) are recorded are installed on a moving object or such a recording of a camera is simulated.

2. The device according to claim 1, characterized in that the display surfaces (16, 17) are each windows, which are largely transparent when the display is switched off and allow a view towards the outside of the room into the surroundings.

3. The device according to claim 1, characterized in that the recording takes place using at least two cameras (22, 23) and the reproduction of the images takes place on at least two display surfaces (16, 17) configured as windows which are located in boundary surfaces (12, 15) of the room approximately at right angles to one another.

4. The device for audio/visual recording and reproduction of images/films according to claim 1, comprising a camera which records a 360° recording all around and at least two spatially separate display surfaces (16, 17) for the reproduction of the images/films recorded by this camera (22, 23), wherein the display surfaces (16, 17) are each windows of a room, wherein the windows are located in boundary surfaces (12, 15) of this room located at an angle to one another and wherein image sections of the images/films of the camera corresponding to the relative spatial position of these windows, which have been recorded directed in respectively different directions, are each reproduced on the display surfaces (16, 17).

5. The device according to claim 1, characterized in that the recording is carried out using at least three cameras (22, 23, 24) directed in respectively different directions or using one camera which records a 360° recording all around and the reproduction of the images is carried out on at least three display surfaces (16, 17, 18) each configured as windows, of which at least two are located in boundary surfaces (12, 15) of the room approximately at right angles to one another and at least two are located in boundary surfaces (12, 13) of the room arranged approximately parallel to one another and opposite one another.

6. The device according to claim 1, characterized in that the recording is carried out using at least four cameras (22, 23, 24, 25) directed in respectively different directions or using one camera which records a 360° recording all around and the reproduction of the images is carried out on at least four display surfaces (16, 17, 18, 19) each configured as windows, of which respectively two are located in boundary surfaces (12, 15) of the room approximately at right angles to one another and respectively two are located in boundary surfaces (12, 13) of the room arranged approximately parallel to one another and opposite one another.

7. The device according to claim 1, characterized in that the recording is carried out using several cameras (22, 23, 24, 25) directed in different directions in each case simultaneously or approximately simultaneously.

8. The device according to claim 1, characterized in that in addition to the image recording, a sound recording is carried out in each case directed in the corresponding direction and during reproduction the sound recording assigned to the respective display surface (16, 17, 18, 19) is played.

9. The device according to claim 1, characterized in that this comprises at least two cameras for audio/visual recording and reproduction of images/films or one camera which records a 360° recording all around, which with regard to its technical specification in the same way as the displays for reproduction of the images/films are equipped in such a manner that they correspond to the human perception as accurately as possible.

10. The device according to claim 9, characterized in that the audio/visual recording takes place taking into account a series of measurable parameters, in particular selected from the group comprising the resolution, the image rate, the contrast, the brightness range, the focal width during the recording and the sound quality, in particular with regard to the spatial impression, the dynamics and/or the sharpness of the reproduction of heights and depths.

11. The device according to claim 1, characterized in that a first display surface (17) is arranged approximately frontally in front of a person (11) observing this and at least one further display surface (16, 18) is arranged approximately laterally to the person observing this, wherein the first display surface (17) and the further display surface (16, 18) preferably adopt an acute angle or a right angle to one another.

12. The device according to claim 1, characterized in that a first display surface (17) is arranged approximately frontally in front of a person (11) observing this, at least one second display surface (16) is arranged approximately laterally to the person observing this, wherein the first display surface (17) and the further display surface (16) preferably adopt an acute angle or a right angle to one another, and at least one third display surface (18) is arranged approximately opposite the further display surface (16) or opposite to this in an offset manner.

13. The device according to claim 1, characterized in that a first display surface (17) is arranged approximately frontally in front of a person (11) observing this and at least one second display surface (19) is arranged approximately behind the person (11) observing this, wherein the first display surface (17) and the second display surface (19) are preferably arranged opposite one another or opposite one another in an offset manner.

14. The device according to claim 1, characterized in that a first display surface (17) is arranged approximately frontally in front of a person observing this, at least one second display surface (16) is arranged approximately laterally to the person observing this, wherein the first display surface (17) and the further display surface (17) preferably adopt an acute angle or a right angle to one another, at least one third display surface (18) is arranged approximately opposite the further display surface (16) or opposite to this in an offset manner and at least one fourth display surface (19) is arranged approximately opposite the first display surface (17) or opposite to this in an offset manner.

15. The device according to claim 1, characterized in that suitable glass surfaces or plastic surfaces in a room or building are used for the display surfaces (17) forming a window, in particular glass doors such as patio doors, balcony doors or glass facade parts, glass partition walls, glass ceilings, glass roofs or glass surfaces of furniture, mirror surfaces, transparent plastic surfaces or the like.

16. A method for audio/visual recording and reproduction of images/films by means of at least three cameras (22, 23, 24) or by means of one camera which records a 360° recording all around, wherein these images/films are provided for a reproduction on spatially separate display surfaces (16, 17, 18) of a device having the features of at least claim 1, characterized in that during recording by means of at least three cameras, images/films are recorded by means of a first camera (23), which records from a movable viewpoint aligned in a first direction, that furthermore images are recorded using a second camera (22) preferably at the same time as the images of the first camera, wherein the second camera (22) records from the same movable viewpoint aligned in a second direction, which is aligned at an acute or a right angle to the first direction and that furthermore, images are recorded using a third camera (24) preferably at the same time as the images of the first and second camera, wherein the third camera (24) records from the same movable viewpoint aligned in a third direction, which is aligned approximately opposite to the first direction or that when using only one camera which records a 360° recording all around, at least three image sections are created from the 360° recording, which show images which are aligned from the same movable viewpoint in a first direction, a second direction and a third direction as described previously.

17. The method according to claim 16, characterized in that furthermore images are recorded using a fourth camera (25) preferably at the same time as the images of the first, second and third camera (23, 22, 24), wherein the fourth camera (25) records aligned in a fourth direction, which is aligned approximately opposite to the second direction or when using only one camera, which records a 360° recording all around, a fourth image section is created which shows images which are aligned from the same movable viewpoint in a fourth direction as described previously.

18. The method according to claim 16, characterized in that the movable viewpoint is located on a movable object (20), in particular on a motor vehicle, a rail vehicle, a bicycle, a boat, an aircraft, a spaceship, a running person or a running animal.
